(19) United States
(12) Patent Application Publication
(10) Pub. No.: US 2008/0103997 A1
(43) Pub. Date: May 1, 2008

(54) ARCHIVAL LEARNING AND FUTURE PERFORMANCE PROJECTION

(76) Inventors: Gene Fein, Lenox, MA (US); Edward Merritt, Lenox, MA (US)

Correspondence Address: BERKELEY LAW & TECHNOLOGY GROUP, LLP, 17933 NW Evergreen Parkway, Suite 250, BEAVERTON, OR, 97006, US

(21) Appl. No.: 11/555,131

(22) Filed: Oct. 31, 2006

(51) Int. Cl. G06F 15/18

(52) U.S. Cl. 706/12

(57) ABSTRACT

Methods, and/or systems, and/or apparatus for archival learning and future performance projection are disclosed.

### FIELD

The subject matter disclosed herein relates to audiovisual learning systems capable of projecting future performance.

### BACKGROUND

In some fields of endeavor, such as, for example, athletics, archived video footage of prior events may be used to study prior performances in an effort to learn about incidences that may occur in the future. Video footage may be edited to conform to certain parameters based upon present or future needs for learning.

For one example, football coaches may spend many hours per week studying game films in an effort to determine tendencies in a future opponent's past performances. Baseball managers and coaches may spend a great deal of time charting pitches and at-bats. However, these process are very labor intensive, and do not provide for automatic updating of analysis as newer video and/or other information becomes available, among other difficulties.

### BRIEF DESCRIPTION OF THE DRAWINGS

The claimed subject matter will be understood more fully from the detailed description given below and from the accompanying drawings of embodiments which should not be taken to limit the claimed subject matter to the specific embodiments described, but are for explanation and understanding only.

FIG. 1 is a block diagram of an embodiment of an example system comprising a database server and a handheld device.

FIG. 2 is a block diagram of an embodiment of an example system comprising a video and/or data input device, a server, and multiple handheld devices.

FIG. 3 is a flow diagram of an embodiment of an example method for archival learning and future performance projection.

FIG. 4 is an example display from an example handheld device depicting a number of menu items.

FIG. 5 is an example display from an example handheld device depicting example future performance projections related to a sporting event.

FIG. 6 is an example display from an example handheld device depicting example future performance projections along with a selected menu item to display video depicting a probable sequence of events.

FIG. 7 is an example display from an example handheld device depicting the display of a video sequence showing a probable sequence of events.

FIG. 8 is an example display from an example handheld device depicting example menu items related to a sporting event.

FIG. 9 is a flow diagram of an embodiment of an example method for archival learning and future performance projection.

FIG. 10 is a flow diagram of an embodiment of an example method for archival learning and future performance projection.

FIG. 11 is a flow diagram of an embodiment of an example method for archival learning and future performance projection.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail.

Some portions of the detailed description that follows are presented in terms of algorithms, programs and/or symbolic representations of operations on data bits or binary digital signals within a computer memory, for example. These algorithmic descriptions and/or representations may include techniques used in the data processing arts to convey the arrangement of a computer system and/or other information handling system to operate according to such programs, algorithms, and/or symbolic representations of operations.

The term “neural network” as used herein may comprise systems, apparatus, and/or methods, etc., which may comprise a parallel process performed by a distributed architecture that may learn to recognize and classify input data and may be constructed in hardware, emulated in software, or a combination of hardware construction and emulation software. However, the scope of the claimed subject matter is not limited in these respects.

An algorithm may be generally considered to be a self-consistent sequence of acts and/or operations leading to a desired result. These include physical manipulations of physical quantities. Usually, though not necessarily, these quantities take the form of electrical and/or magnetic signals capable of being stored, transferred, combined, compared, and/or otherwise manipulated. It has proven convenient at times, principally for reasons of common usage, to refer to these signals as bits, values, elements, symbols, characters, terms, numbers and/or the like. It should be understood, however, that all of these and/or similar terms are to be associated with the appropriate physical quantities and are merely convenient labels applied to these quantities.

Unless specifically stated otherwise, as apparent from the following discussions, it is appreciated that throughout the specification discussion utilizing terms such as processing, computing, calculating, determining, and/or the like, refer to the action and/or processes of a computer and/or computing system, and/or similar electronic computing device, that manipulate or transform data represented as physical, such as electronic, quantities within the registers and/or memories of the computer and/or computing system and/or similar electronic and/or computing device into other data similarly represented as physical quantities within the memories, registers and/or other such information storage, transmission and/or display devices of the computing system and/or other information handling system.

Embodiments claimed may include apparatuses for performing the operations herein. This apparatus may be specially constructed for the desired purposes, or it may comprise a general purpose computing device selectively activated and/or reconfigured by a program stored in the device. Such a program may be stored on a storage medium, such as, but is not limited to, any type of disk including floppy disks, optical disks, CD-ROMs, magnetic-optical disks, read-only memories (ROMs), random access memories (RAMs), electrically programmable read-only memories (EPROMs), electrically erasable and/or programmable read only memories (EEPROMs), flash memory, magnetic and/or optical cards, and/or any other type of media suitable for storing electronic instructions, and/or capable of being coupled to a system bus for a computing device and/or other information handling system.

The processes and/or displays presented herein are not inherently related to any particular computing device and/or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments are not described with reference to any particular programming language. It will be appreciated that a variety of programming languages may be used to implement the teachings described herein.

In the following description and/or claims, the terms coupled and/or connected, along with their derivatives, may be used. In particular embodiments, connected may be used to indicate that two or more elements are in direct physical and/or electrical contact with each other. Coupled may mean that two or more elements are in direct physical and/or electrical contact. However, coupled may also mean that two or more elements may not be in direct contact with each other, but yet may still cooperate and/or interact with each other.

It should be understood that certain embodiments may be used in a variety of applications. Although the claimed subject matter is not limited in this respect, the circuits disclosed herein may be used in many apparatuses such as in the transmitters and/or receivers of a radio system. Radio systems intended to be included within the scope of the claimed subject matter may include, by way of example only, wireless personal area networks (WPAN) such as a network in compliance with the WiMedia Alliance, a wireless local area networks (WLAN) devices and/or wireless wide area network (WWAN) devices including wireless network interface devices and/or network interface cards (NICs), base stations, access points (APs), gateways, bridges, hubs, cellular radiotelephone communication systems, satellite communication systems, two-way radio communication systems, one-way pagers, two-way pagers, personal communication systems (PCS), personal computers (PCs), personal digital assistants (PDAs), and/or the like, although the scope of the claimed subject matter is not limited in this respect.

Types of wireless communication systems intended to be within the scope of the claimed subject matter may include, although are not limited to, Wireless Local Area Network (WLAN), Wireless Wide Area Network (WWAN), Code Division Multiple Access (CDMA) cellular radiotelephone communication systems, Global System for Mobile Communications (GSM) cellular radiotelephone systems, North American Digital Cellular (NADC) cellular radiotelephone systems, Time Division Multiple Access (TDMA) systems, Extended-TDMA (E-TDMA) cellular radiotelephone systems, third generation (3G) systems like Wideband CDMA (WCDMA), CDMA-2000, and/or the like, although the scope of the claimed subject matter is not limited in this respect.

Reference throughout this specification to one embodiment or an embodiment means that a particular feature, structure, or characteristic described in connection with the embodiment is included in at least one embodiment. Thus, the appearances of the phrase in one embodiment or an embodiment in various places throughout this specification are not necessarily all referring to the same embodiment. Furthermore, the particular features, structures, or characteristics may be combined in one or more embodiments.

A “data transmission network” as referred to herein relates to infrastructure that is capable of transmitting information among nodes which are coupled to the data transmission network. For example, a data transmission network may comprise links capable of transmitting data between nodes according to one or more data transmission protocols. Such links may comprise one or more types of transmission media capable of transmitting digital objects from a source to a destination. However, these are merely examples of a data transmission network.

“Instructions” as referred to herein relate to expressions which represent one or more logical operations. For example, instructions may be “machine-readable” by being interpretable by a machine for executing one or more operations on one or more data objects. However, this is merely an example of instructions and claimed subject matter is not limited in this respect. In another example, instructions as referred to herein may relate to encoded commands which are executable by a processing circuit having a command set which includes the encoded commands. Such an instruction may be encoded in the form of a machine language understood by the processing circuit. Again, these are merely examples of an instruction and claimed subject matter is not limited in this respect.

“Storage medium” as referred to herein relates to media capable of maintaining expressions which are perceivable by one or more machines. For example, a storage medium may comprise one or more storage devices for storing machine-readable instructions and/or information. Such storage devices may comprise any one of several media types including, for example, magnetic, optical or semiconductor storage media. However, these are merely examples of a storage medium and claimed subject matter is not limited in these respects.

“Logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a storage medium in combination with processing circuitry to execute such machine-readable instructions. However, these are merely examples of structures which may provide logic and claimed subject matter is not limited in this respect.

Unless specifically stated otherwise, as apparent from the following discussion, it is appreciated that throughout this specification discussions utilizing terms such as “processing,” “computing,” “calculating,” “selecting,” “forming,” “enabling,” “inhibiting “identifying,” “initiating,” “receiving,” “transmitting,” “determining” and/or the like refer to the actions and/or processes that may be performed by a computing platform, such as a computer or a similar electronic computing device, that manipulates and/or transforms data represented as physical electronic and/or magnetic quantities and/or other physical quantities within the computing platform's processors, memories, registers, and/or other information storage, transmission, reception and/or display devices. Further, unless specifically stated otherwise, process described herein, with reference to flow diagrams or otherwise, may also be executed and/or controlled, in whole or in part, by such a computing platform.

As discussed previously, prior processes for analyzing video and/or other information for athletic endeavors, for example, are labor intensive and are not able to provide automatic updating of analysis as more current information becomes available.

Embodiments described herein may provide for real time video data evaluation and subsequent probabilities and comparisons which may be made in the field gathering current data and comparing that data to archival data to yield real time probabilities using both past and present data. Embodiments described herein may provide real time, mobile, video platforms and/or display devices which may synthesize present and past performance information for observation and generation of real time future outcomes based upon probabilities derived from any of a wide range of data parameters. One or more embodiments may comprise a neural network, although the scope of the claimed subject matter is not limited in this respect.

For one example embodiment, a portable and/or handheld device such as a wireless tablet touch screen display or a cellular phone may be provide for a user. The user may select from a menu which data set the user is interested in. The user may then research archival data and may receive text and/or visual (perhaps video) information retrieved from a database and delivered to the user's portable and/or handheld device. Additional text and/or video information may be synthesized into the database in real time, or approximately real-time. In this manner, a computing platform having access to the database may generate responses based upon the latest data conditions and may present historically relevant data refined to specialized, sorted categories. Probabilities relating to future behavior, events, and/or conditions may be formulated as well.

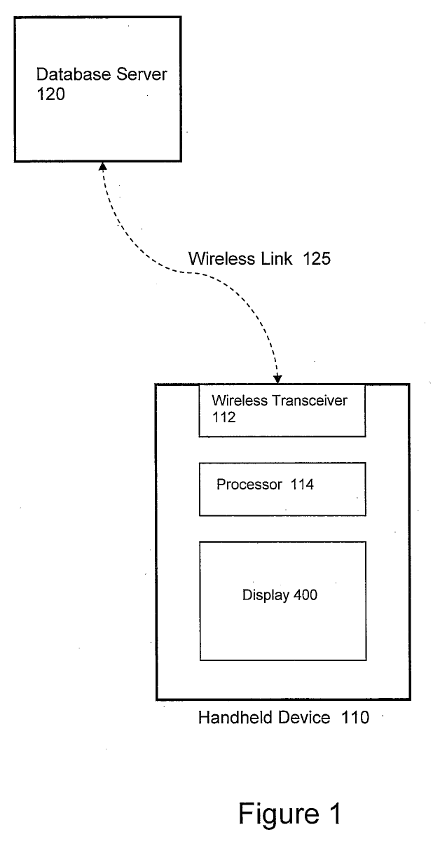

FIG. 1 is a block diagram of an embodiment of an example system comprising a database server 120 and a handheld device 110. For this example embodiment, database server 120 may be coupled to handheld device 110 via a wireless link 125. Handheld device 110 may comprise any of a wide range of portable computing platforms, including, but not limited to, tablet touch screen devices and/or cellular phones, although the scope of the claimed subject matter is not limited in this respect. For this example, device 110 comprises a wireless transceiver capable of providing communications with database server 120. Device 110 further comprises a processor 114 and a display 400. Display 400 may comprise a touch screen for this example embodiment, although again the scope of the claimed subject matter is not limited in this respect. Further, although this example depicts a handheld device 110, other embodiments are possible using computing platforms that are not handheld. Also, embodiments are possible where the database server and device 110 are implemented as a single system, such as perhaps a personal computer or other computing platform, although the scope of the claimed subject matter is not limited in this respect.

Further, for one or more embodiments, a neural network may be employed within the system of FIG. 1. The neural network may comprise the server 120 or device 110, or distributed among server 120 and device 110. However, the scope of the claimed subject matter is not limited in these respects.

For one or more embodiments, the video record of a professional sports league may be largely or fully (or nearly fully) catalogued and every play, pitch, shot, and/or other moments from game action may be captured, labeled, and/or defined by various criterion and catalogued within a database and made instantly or nearly instantly available via digital storage and software programs running on one or more computing platforms. The data may be tagged upon entry into the database with one or more data tags so that the footage (if video data) can be accessed by specific criterion queries or sets of queries. This may enable the user to be able to select any set of footage sequences via a set of sort able commands which may be used to identify participants as well as any of a wide range of various isolated or combined defined game conditions.

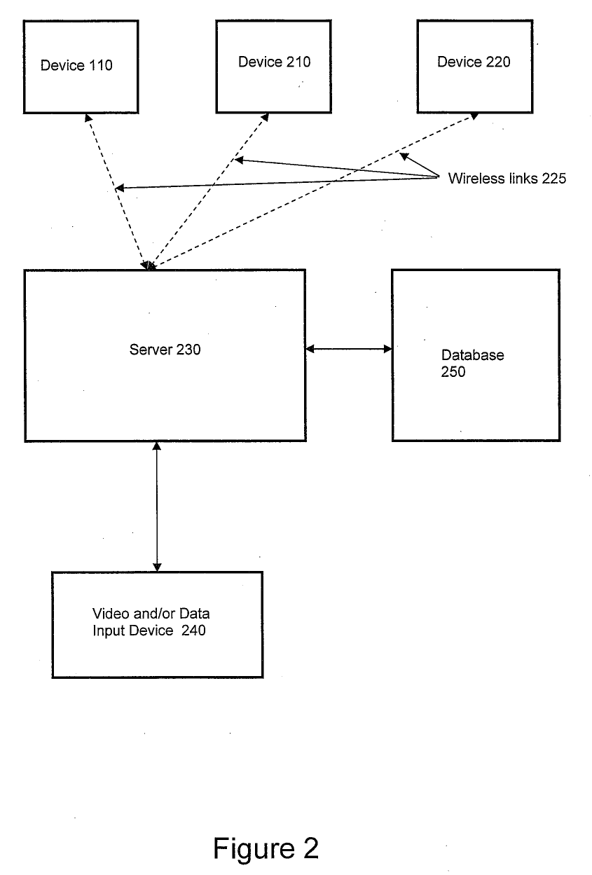

FIG. 2 is a block diagram of an embodiment of an example system comprising a video and/or data input device 240, a server 230, and multiple handheld devices 110, 210, and 220. A database 250 is coupled to and/or incorporated within server 230. Devices 110,210, and/or 220 may be coupled to server 230 via one or more wireless links. Video and/or data input device 240 may also be coupled to server 230 via a wireless link. Of course, the embodiment depicted in FIG. 2 is merely on possible embodiment, and the scope of the claimed subject matter is not limited in this respect.

Video may be encoded and labeled with various criteria defined by a database designer. In the case of real time video and data, it may be advantageous to encode and label the video and/or data as quickly as possible (perhaps within seconds of an event) so that the system may reply quickly to the latest data circumstances. The video and/or other information may be captured and labeled by users observing, for example, an athletic event. Video may be logged into database 250 with text data and stored on fast hard drive arrays. Data may be delivered from database 250 to server 230 based upon a query to the database from the server. Server may or may not perform various calculations or manipulations of the data before delivering the information to one or more of devices 110, 210, and 220. The example embodiments described herein may incorporate security features such as encryption and decryption to ensure data integrity and security between transfer points, although the scope of the claimed subject matter is not limited in this respect.

Also, for one or more embodiments, a neural network may be employed within the system of FIG. 2. The neural network may comprise server 230, video and/or input device 240, device 110, device 210, or device 220, or distributed among a combination of any of server 230, video and/or input device 240, device 110, device 210, and/or device 220. However, the scope of the claimed subject matter is not limited in these respects.

For one or more embodiments described herein, an end user may view historical video sequences that may match the events he has entered, displaying those video sequences on a wireless device. The user may also have those historical video actions reduced to text. For example, if an end user has requested a pitch sequence from the last time a particular baseball pitcher pitched to him during a night game at a particular ballpark, the user may view the actual video sequence of pitches that occurred during that event, or may receive text documentation of the events describing each pitch and result in sequence. Both video and/or text data with or without descriptive audio may be viewed by the user via a wireless device in a dugout or clubhouse, as the game is being played live. The system may also log video in real time so that the user can view the last live pitch sequence thrown to a hitter. Real time data entry may help the system to calculate probabilities of what a pitcher will throw to a hitter in the next at bat, or even for the very next pitch. The system may generate future probabilities based upon some or all archived material up to and including the most recent pitch thrown. This may enable a hitter (user) to view text responses as to probabilities of pitch sequences for his next at bat against a pitcher, and/or may enable the user to view probabilities in the form of an actual video sequence of the pitcher throwing probable forecasted pitches. Of course, these are merely examples of how the embodiments described herein may be utilized, and the scope of the claimed subject matter is not limited in these respects.

Embodiments may also be used as a learning tool for pitchers about batters, fielders, umpires, base runners, etc., and for batters to learn where position players are likely to be placed under defined circumstances. For example, a pitcher may view past pitch sequences that he threw to a particular batter, past sequences that other pitchers threw to the same batter, past sequences of pitches that the batter hit hard, swung and missed, took for a ball, or took for a strike, etc. The pitcher may view how the batter did with a specific count in a single or series of at-bats under specific game conditions. The pitcher may view a batter's success rate a specific kind of pitch, during a specific time period with particular game situations culled from multiple at bats against multiple pitchers. For example, a pitcher may request a sequence showing how a particular batter hit outside sliders registering 87 mph or greater, after the 6^{th} inning, while ahead in the count, at home, during a night game within the last 7 days. The pitcher/user may also query the system to generate a pitch sequence that would be most likely to get a specific hitter out, strike the hitter out, yield a fly ball, or a ground ball, etc. under the circumstances. The system may also auto load the current game circumstances to use that data as part of its analysis creating fewer fields of information that need to be filled in by the end user, as well as speeding answers to the end user. The example embodiments described herein may be utilized by players, coaches, managers, fans and/or team management personnel, although the scope of the claimed subject matter is not limited in these respects.

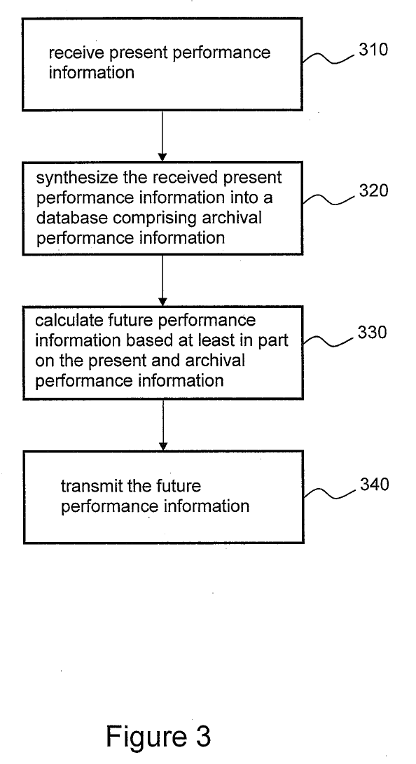

FIG. 3 is a flow diagram of an embodiment of an example method for archival learning and future performance projection. This example method may be performed by a system such as those shown above in connection with FIGS. 1 and 2, discussed above, although the scope of the claimed subject matter is not limited in this respect. At block 310, present performance information may be received, and at block 320, the received present performance information may be synthesized into a database comprising archival performance information. At block 330, future performance information may be calculated based at least in part on the present and archival performance information. At block 340, the future performance information may be transmitted. An embodiment in accordance with claimed subject matter may include all, more than all or less than all of blocks 310-340. Furthermore the order of blocks 310-340 is merely one example order, and scope of the claimed subject matter is not limited in this respect.

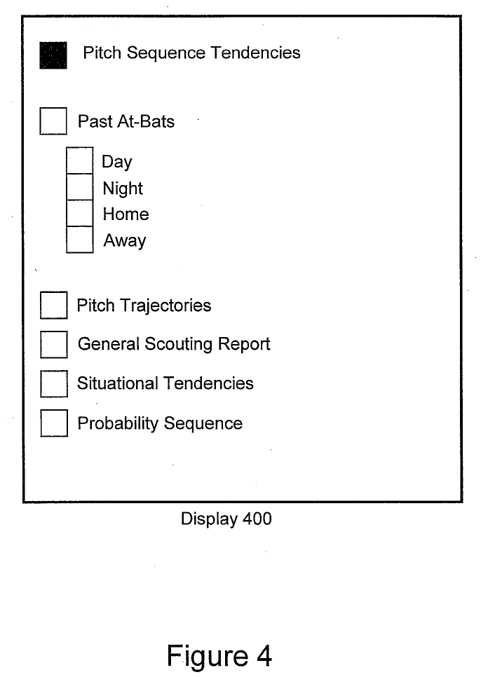

FIG. 4 shows example display 400 from example handheld device 110, where the display depicts a number of menu items in the form of a navigation screen. For this embodiment, display 400 comprises a touch-screen. For this example embodiment, the sample navigation depicts a baseball game application. The upper portion of the screen includes a menu item that allows for a user to select pitch sequence tendencies that may help predict what pitch is most likely to be thrown based upon the available data including how the pitcher is currently pitching, game conditions, previous performance against this team, batter in similar conditions, etc. Some of these factors are described above. After each pitch, the probabilities may be updated in response to the previous pitch being registered into the system as a data point. Other criteria that may be sorted for answers include past at bats by this hitter against this pitcher or past at-bats in general. At-bats for the hitter may also be sorted by day games, night games, home games, and away games, as depicted on example display 400 in FIG. 4. These criteria may also be used in conjunction with other criteria to generate a more specified data result. Other data made available by the system may include, but are not limited to, items such as Pitch Trajectory enabling the study of the trajectory that a pitcher's different pitches take on their way across the plate. General scouting reports may also be available in synopsis or in detailed form containing video, audio and/or text. A situational tendency option may query the system for game situations as close as possible to the one taking place in real time and then generate probabilities for future behavior based upon that data factoring in not only the data at hand but also weighing current performance and/or momentum of current performance as a prominent factor to be correlated along with past data. Another real time feature may include a probability sequence for a current hitter and for each at bat that a hitter may have through out a game based upon the same mix of available real time data and/or archival data available in the system.

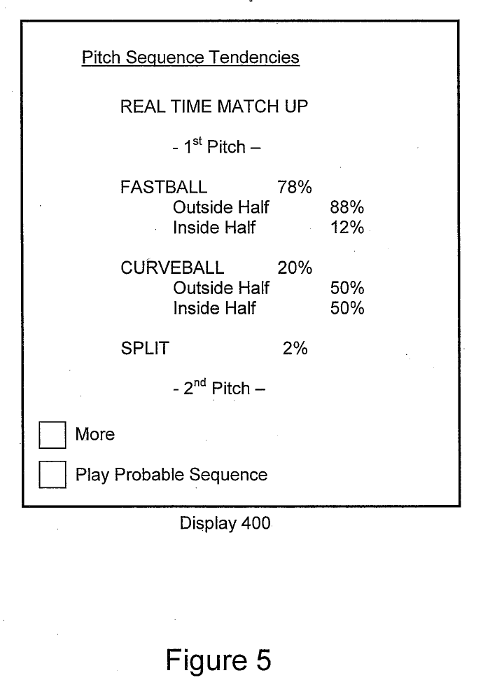

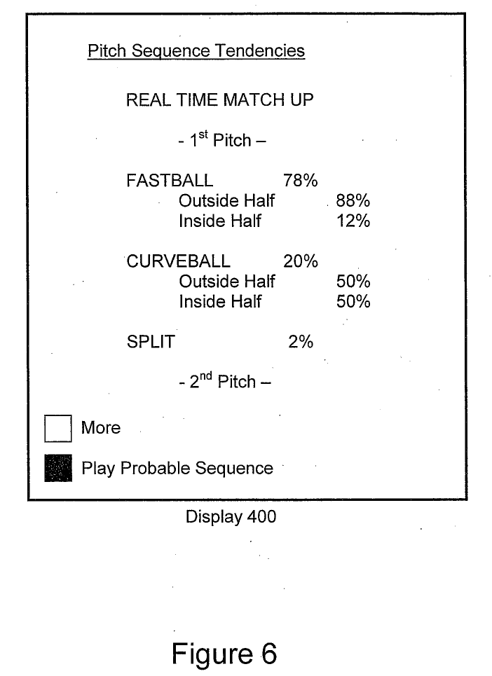

FIG. 5 is an example display from an example handheld device depicting example future performance projections related to a sporting event. As was seen in FIG. 4, for this example the “pitch sequence tendencies” menu item is selected, resulting in this current example shown in FIG. 5. In this example, an example of pitch sequence tendencies are displayed based upon the selected pitch sequence query from FIG. 4. This illustration breaks down the percentage chance of which pitch a pitcher may throw on the first pitch as a real time or nearly real-time calculation. Other pitch probabilities based upon the same real time data are also projected. For this example, it is predicted based on archival and present information that for this particular example pitcher for this particular batter under these conditions, the pitcher has a 78% chance of throwing a fastball for the first pitch of an at-bat. Further, for this example, it is predicted that the pitcher has an 88% chance of throwing the fastball over the outer-half of home plate. One may also observer that for this example the pitcher has a 20% chance of throwing a curveball for the first pitch, and that it's equally likely that the pith will be over either the inner or outer half of the plate. Other predictions may be calculated, as well. The example display of FIG. 5 is merely an example, and any of a wide range of information may be displayed. Further for this example, the user may also be given the option to generate a video sequence of what the probable pitch sequence will be. Within that sequence a user may study details of pitch trajectories and other sorts of data. FIG. 6 depicts the “play probably sequence” menu item as having been selected.

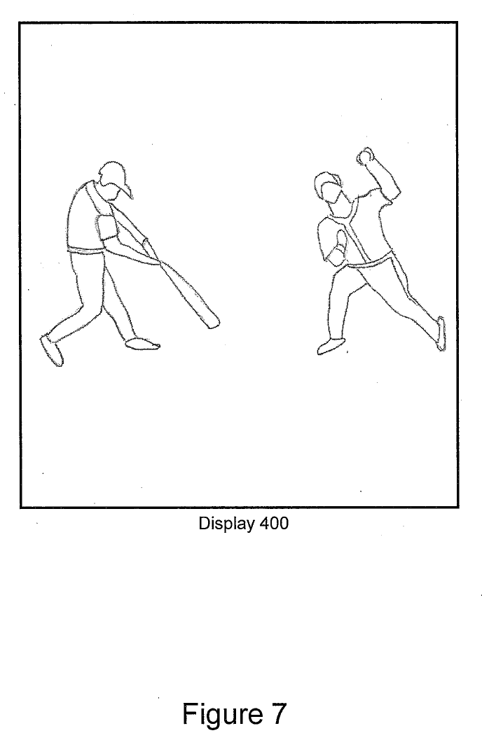

FIG. 7 is an example display 400 from example handheld device 110 depicting the display of the video sequence showing the probable sequence of events depicted above in FIGS. 5 and 6. For FIG. 7, a single frame of a video sequence is depicted. The video sequence for this example is that of a pitcher throwing a ball to a batter. Frames of a video sequence may be frozen, slowed down, played in fast motion, etc., with audio enhancements and/or with overlaid graphical analysis based upon user specifications. Of course, this is merely one example of the type of video and/or other data that may be displayed. Further, while the example embodiments above discuss embodiments used for baseball, the scope of the claimed subject matter is not limited in this respect.

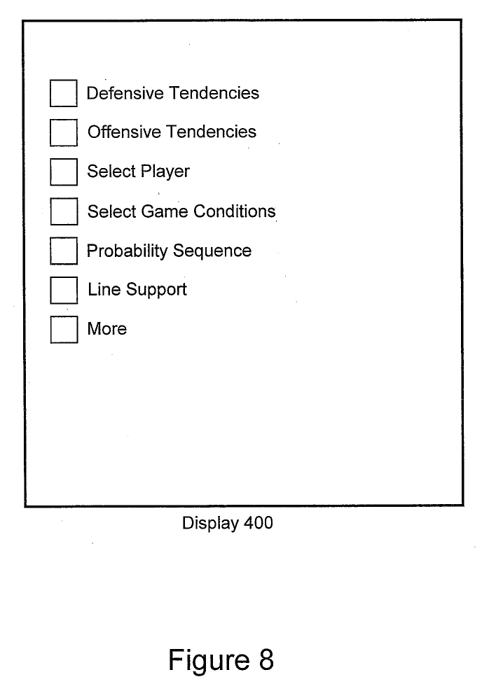

FIG. 8 is an example display 400 from example handheld device 110 depicting example menu items related to football. Among the possible menu items that may be included, and as depicted in FIG. 8, are defensive tendencies, offensive tendencies, data for a selected player, data for specific game conditions, probability sequences, line support (offensive and/or defensive lines), and/or other items. These are merely examples of the types of information that may be gathered, archived, and/or predicted for football.

Although the above embodiments are described in connection with athletics, other embodiments are possible for archival learning and future performance prediction in other areas of endeavor. For example, one or more embodiments may be used in connection with business ventures, perhaps with the film industry, although the scope of the claimed subject matter is not limited in this respect. The business and critical success of films based upon the analysis of a number of past and present factors as well as future probabilities may be utilized to generate similar useful information as may be generated for athletic events. Probable success rates and ranges may be generated based upon factors such as cast, plot (current societal trends may be factored in), budget, domestic distribution predictors, international distribution predictors, marketing plan, publicity plan, economic conditions, and/or relationship to archived data, etc. Audiovisual instances of actors, scenes, and/or publicity may be manually or automatically formulated and entered into the system from a menu to yield different probabilities for success within differing distribution and/or expense models.

By piecing together different kinds of scenes in different sequences, involving different genres, actors, writers, directors, photographic and special effects techniques, for a films release at different times of the year, in years where releases in terms of number of films and genres follow different patterns, when combined with data from the current worldwide distribution platform landscape, this info along with different publicity plans, marketing plans and budgets may be used to create a series of forecast assessments that can be made projecting profitability as well as critical appeal projections. These assessments may be used during the planning, development, production and/or marketing phases of a film or slate of films either from behind a desk, or in real time from a movie set or other mobile location. Assessments generated by the system (perhaps such as that described above in connection with FIGS. 1 and 2) may be general, specific to different platforms and territories, or both. The system may generate specific results for example questions such as, “what if I used actor A instead of actor B in this role?” What is the probability of success for domestically releasing a 100 million dollar budget animation film in the 2^{nd} week in August?” Etc. These questions, as well as any of a wide range of other questions that may be posed using different search and/or query parameters, may generate specific answers by the system.

As a further example of an embodiment of a method and/or apparatus for archival learning and future performance prediction, a model may be developed to predict percolation test success in the field based upon soil condition, weather conditions, and/or historic findings if matched against an archival database of similar findings. Real time data and/or audiovisual images may be sent to the database from the field to generate comparisons and/or results predictors which may then be relayed back to a portable device in the field in the form of hard data predictors as well as visual modeling probabilities. In practice, geological surveys, GPS data, and recent weather conditions and forecasts may provide preliminary data on where a percolation test may have its best chance for success. Once in the field, specific data can be uploaded into the system from micro pits and test holes to determine where in the field one may have the greatest probability for success. Of course, percolation testing in merely one example embodiment, and the scope of the claimed subject matter is not limited in this respect.

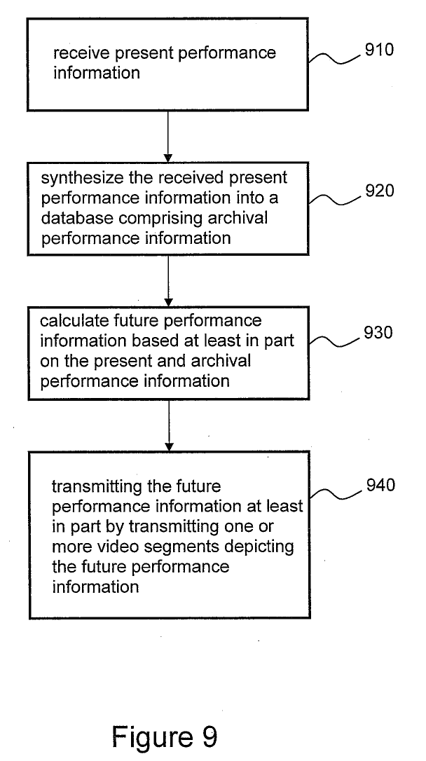

FIG. 9 is a flow diagram of an embodiment of an example method for archival learning and future performance projection. At block 910, present performance information may be received. The present performance may relate to any of a wide range of information. For one embodiment, the present performance information may related to a pitched baseball, although the scope of the claimed subject matter is not limited in this respect. For example, other embodiments are possible where the present performance information may related to any of a wide range of athletic endeavors and/or business ventures, including motion pictures. Some examples of possible present performance information are discussed above. The present performance information may include video information, text information, and/or audio information, although the scope of the claimed subject matter is not limited in this respect.

At block 920, the received present performance information may be synthesized into a database comprising archival performance information, and at block 930 future performance information based at least in part on the present and archival performance information may be calculated. Further, at block 940 the future performance information may be transmitted at least in part by transmitting one or more video segments depicting the future performance information. An embodiment in accordance with claimed subject matter may include all, more than all or less than all of blocks 910-940. Furthermore the order of blocks 910-940 is merely one example order, and scope of the claimed subject matter is not limited in this respect.

For one example embodiment where the present performance information relates to a pitched baseball, the calculated future performance information may comprise information related to a probable future sequence of pitches. The transmitted video segments may depict such a sequence of pitches. Also for an embodiment, the video segments may comprise archived video segments from previous pitches thrown by a selected pitcher. For another example embodiment involving a motion picture venture, the transmitted video segments may comprise archived scenes from other motion pictures. The scenes may represent scenes predicted in the calculated future performance information operation to provide a high likelihood of popular appeal, commercial success, critical approval, etc. Of course, these are merely examples of embodiments for methods for archival learning and future performance Iprojection, and the scope of the claimed subject matter is not limited in these regards.

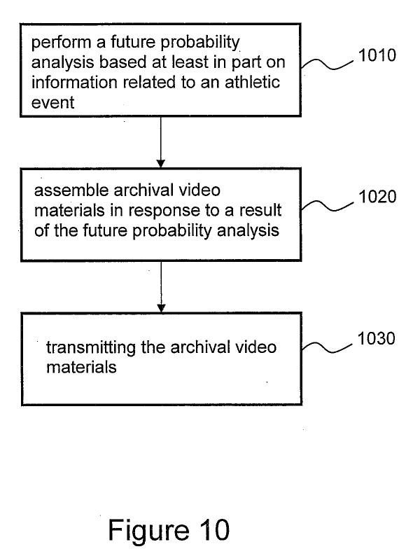

FIG. 10 is a flow diagram of an embodiment of an example method for archival learning and future performance projection. At block 1010, a future probability analysis may be performed based at least in part on information related to an athletic event. For one example embodiment, the information related to an athletic event may comprise information related to pitched baseball. Also for an embodiment, the information related to the pitched baseball may include video information, text information, and/or audio information, although the scope of the claimed subject matter is not limited in this respect. Embodiments in accordance with claimed subject matter may relate to other aspects of baseball such at batting and/or fielding, for example, and may also relate to any of a wide range of athletic events and/or endeavors, including but not limited to football as discussed above in connection with other example embodiments.

At block 1020, archival video materials may be assembled in response to a result of the future probability analysis. For an example where the future performance projection is related to a pitched baseball, the archival video materials may comprise one or more video segments depicting a projected sequence of pitches, although the scope of the claimed subject matter is not limited in this respect. At block 1030, the archival video materials may be transmitted, for example to a user. As used herein, the term “transmit” is meant to include any technique or device for delivering information to a user or allowing a user to view or otherwise perceive the information. An embodiment in accordance with claimed subject matter may include all, more than all or less than all of blocks 1010-1030. Furthermore the order of blocks 1010-1030 is merely one example order, and scope of the claimed subject matter is not limited in this respect.

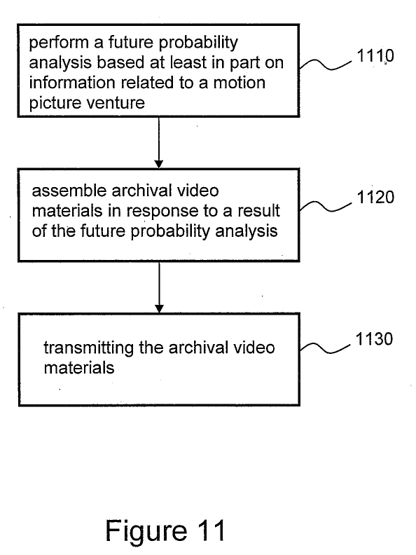

FIG. 11 is a flow diagram of an embodiment of an example method for archival learning and future performance projection. At block 1110, a future probability analysis may be performed based at least in part on information related to a motion picture venture. For one example embodiment, the information related to a motion picture may comprise information related to any of various aspects of motion pictures, including, but not limited to, plot, actors, directors, business plans, etc. Also for an embodiment, the information related to the motion picture venture may include video information, text information, and/or audio information, although the scope of the claimed subject matter is not limited in this respect. Further, the probability analysis for an example embodiment may comprise a projection of commercial success, although other embodiments may project popular appeal, critical appeal, costs, etc. Of course, the scope of the claimed subject matter is not limited in these respects.

At block 1120, archival video materials may be assembled in response to a result of the future probability analysis. For an example where the future performance projection is related to commercial success of a motion picture venture, the archival video materials may comprise one or more video segments depicting a possible sequence scenes from previous motion pictures, although the scope of the claimed subject matter is not limited in this respect. For an embodiment, the sequence of scenes may represent a sequence that may be projected to provide maximum commercial success. At block 1130, the archival video materials may be transmitted, for example to a user. An embodiment in accordance with claimed subject matter may include all, more than all or less than all of blocks 1110-1130. Furthermore the order of blocks 1110-1130 is merely one example order, and scope of the claimed subject matter is not limited in this respect.

In the preceding description, various aspects of claimed subject matter have been described. For purposes of explanation, systems and configurations were set forth to provide a thorough understanding of claimed subject matter. However, it should be apparent to one skilled in the art having the benefit of this disclosure that claimed subject matter may be practiced without the specific details. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all such modifications and/or changes as fall within the true spirit of claimed subject matter.

What is claimed is:

1. A method, comprising:
receiving present performance information;
synthesizing the received present performance information into a database comprising archival performance information;
calculating future performance information based at least in part on the present and archival performance information; and
transmitting the future performance information.

2. The method of claim 1, wherein the present performance information is synthesized into the database in approximately real-time.

3. The method of claim 2, wherein the future performance information is calculated approximately immediately after the present performance information is synthesized into the database.

4. The method of claim 1, wherein calculating the future performance information comprises automatically calculating the future performance information in response to receiving the present performance information.

5. The method of claim 1, wherein receiving present performance information comprises receiving data related to a sporting event.

6. The method of claim 5, wherein the sporting event comprises a baseball game.

7. The method of claim 6, wherein the present performance information comprises information relating to a pitched ball.

8. The method of claim 7, wherein the information relating to the pitched ball comprises information related to pitch type.

9. The method of claim 7, wherein the information relating to the pitched ball comprises information related to pitch location.

10. The method of claim 7, wherein the information relating to the pitched ball comprises information related to pitch velocity.

11. The method of claim 6, wherein the present performance information comprises information relating to a batted ball.

12. The method of claim 11, wherein the information relating to the batted ball comprises information related to a result of an at-bat.

13. The method of claim 11, wherein the information relating to the batted ball comprises information related to defender formation.

14. The method of claim 6, wherein calculating the future performance information comprises calculating a predicted next pitch type.

15. The method of claim 6, wherein calculating the future performance information comprises calculating a predicted next pitch location.

16. The method of claim 6, wherein calculating the future performance information comprises calculating a predicted result of a next at-bat.

17. The method of claim 5, wherein the sporting event comprises a football game.

18. The method of claim 17, wherein the present performance information comprises information relating to an offensive play.

19. The method of claim 17, wherein the information relating to the offensive play comprises information related to player formation.

20. The method of claim 17, wherein the information relating to the offensive play comprises information related to play type.

21. The method of claim 17, wherein the information relating to the offensive play comprises information related to yards gained.

22. The method of claim 17, wherein calculating the future performance information comprises calculating a predicted next offensive play type.

23. The method of claim 17, wherein calculating the future performance information comprises calculating a predicted next defensive formation.

24. The method of claim 1, wherein receiving present performance information comprises receiving data related to a business venture.

25. The method of claim 24, wherein the business venture comprises a motion picture.

26. The method of claim 25, wherein the present performance information comprises information relating to an actor.

27. The method of claim 25, wherein the present performance information comprises information relating to a plot.

28. The method of claim 25, wherein the present performance information comprises information relating to a budget.

29. The method of claim 25, wherein the present performance information comprises information relating to a distribution plan.

30. The method of claim 25, wherein the present performance information comprises information relating to a publicity plan.

31. The method of claim 25, wherein calculating the future performance information comprises calculating a predicted critical appeal result.

32. The method of claim 25, wherein calculating the future performance information comprises calculating a predicted profitability amount.

33. The method of claim 1, wherein transmitting the future performance information comprises transmitting the future performance information via a wireless interconnect.

34. The method of claim 1, wherein receiving present performance information comprises receiving present performance information via a wireless interconnect.

35. An article, comprising: a storage medium having stored thereon instructions that, if executed, result in:
receiving present performance information;
synthesizing the received present performance information into a database comprising archival performance information;
calculating future performance information based at least in part on the present and archival performance information; and
transmitting the future performance information.

36. The article of claim 35, wherein the present performance information is synthesized into the database in approximately real-time.

37. The article of claim 36, wherein the future performance information is calculated approximately immediately after the present performance information is synthesized into the database.

38. The article of claim 35, wherein calculating the future performance information comprises automatically calculating the future performance information in response to receiving the present performance information.

39. The article of claim 35, wherein receiving present performance information comprises receiving data related to a sporting event.

40. The article of claim 39, wherein the sporting event comprises a baseball game.

41. The article of claim 40, wherein the present performance information comprises information relating to a pitched ball.

42. The article of claim 41, wherein the information relating to the pitched ball comprises information related to pitch type.

43. The method of claim 41, wherein the information relating to the pitched ball comprises information related to pitch location.

44. The article of claim 41, wherein the information relating to the pitched ball comprises information related to pitch velocity.

45. The article of claim 40, wherein the present performance information comprises information relating to a batted ball.

46. The article of claim 45, wherein the information relating to the batted ball comprises information related to a result of an at-bat.

47. The article of claim 45, wherein the information relating to the batted ball comprises information related to defender formation.

48. The article of claim 40, wherein calculating the future performance information comprises calculating a predicted next pitch type.

49. The article of claim 40, wherein calculating the future performance information comprises calculating a predicted next pitch location.

50. The article of claim 40, wherein calculating the future performance information comprises calculating a predicted result of a next at-bat.

51. The article of claim 39, wherein the sporting event comprises a football game.

52. The article of claim 51, wherein the present performance information comprises information relating to an offensive play.

53. The article of claim 52, wherein the information relating to the offensive play comprises information related to player formation.

54. The article of claim 52, wherein the information relating to the offensive play comprises information related to play type.

55. The article of claim 52, wherein the information relating to the offensive play comprises information related to yards gained.

56. The article of claim 51, wherein calculating the future performance information comprises calculating a predicted next offensive play type.

57. The article of claim 51, wherein calculating the future performance information comprises calculating a predicted next defensive formation.

58. The article of claim 35, wherein receiving present performance information comprises receiving data related to a business venture.

59. The article of claim 58, wherein the business venture comprises a motion picture.

60. The article of claim 59, wherein the present performance information comprises information relating to an actor.

61. The article of claim 59, wherein the present performance information comprises information relating to a plot.

62. The article of claim 59, wherein the present performance information comprises information relating to a budget.

63. The article of claim 59, wherein the present performance information comprises information relating to a distribution plan.

64. The article of claim 59, wherein the present performance information comprises information relating to a publicity plan.

65. The article of claim 59, wherein calculating the future performance information comprises calculating a predicted critical appeal result.

66. The article of claim 59, wherein calculating the future performance information comprises calculating a predicted profitability amount.

67. The article of claim 35, wherein transmitting the future performance information comprises transmitting the future performance information via a wireless interconnect.

68. The article of claim 35, wherein receiving present performance information comprises receiving present performance information via a wireless interconnect.

69. An apparatus, comprising:
a computing platform configured to perform the method according to claim 1 during operation.

70. An apparatus, comprising:
means for receiving present performance information;
means for synthesizing the received present performance information into a database comprising archival performance information;
means for calculating future performance information based at least in part on the present and archival performance information; and
means for transmitting the future performance information.

71. The apparatus of claim 70, wherein the means for synthesizing the received present performance information synthesizes the present performance information into the database in approximately real-time.

72. The apparatus of claim 71, wherein the means for calculating calculates the future performance information approximately immediately after the present performance information is synthesized into the database.

73. The apparatus of claim 70, wherein the means for calculating the future performance information comprises means for automatically calculating the future performance information in response to receiving the present performance information.

74. The apparatus of claim 73, wherein the means for receiving present performance information comprises means for receiving information related to a sporting event.

75. The apparatus of claim 74, wherein the means for calculating future performance information comprises means for calculating future performance information related to the sporting event.

76. The apparatus of claim 73, wherein the means for receiving present performance information comprises means for receiving information related to a business venture.

77. The apparatus of claim 76, wherein the means for calculating future performance information comprises means for calculating future performance information related to the business venture.

78. A method, comprising:
receiving present performance information;
synthesizing the received present performance information into a database comprising archival performance information;
calculating future performance information based at least in part on the present and archival performance information; and
transmitting the future performance information at least in part by transmitting one or more video segments depicting the future performance information.

79. The method of claim 78, wherein transmitting one or more video segments depicting the future performance information comprises transmitting one or more video segments previously stored as archival performance information.

80. The method of claim 79, wherein said synthesizing the received present performance information, said calculating the future performance information, and said transmitting one or more video segments depicting the future performance information are automatically performed in response to said receiving the present performance information.

81. The method of claim 80, wherein said receiving the present performance information and transmitting one or more video segments depicting the future performance information occurs in approximately real-time.

82. The method of claim 79, wherein receiving present performance information comprises receiving information related to a pitched baseball.

83. The method of claim 82, wherein the information related to the pitched baseball comprises a video segment depicting the pitched baseball.

84. The method of claim 83, wherein the information related to the pitched baseball further comprises text information describing one or more characteristics of the pitched baseball.

85. The method of claim 83, wherein transmitting one or more video segments depicting the future performance information comprises transmitting a sequence of video segments previously stored as archival performance information, wherein the sequence of video segments depict a likely future sequence of pitches.

86. A method, comprising:
receiving information related to a business venture;
synthesizing the received information into a database comprising archival performance information;
calculating future performance information based at least in part on the received information related to the business venture and the archival performance information; and
transmitting the future performance information at least in part by transmitting one or more video segments depicting the future performance information.

87. The method of claim 86, wherein receiving information related to business venture comprises receiving information related to a proposed motion picture.

88. The method of claim 87, wherein transmitting one or more video segments depicting the future performance information comprises transmitting one or more video segments previously stored as archival performance information.

89. The method of claim 88, wherein said synthesizing the received present performance information, said calculating the future performance information, and said transmitting one or more video segments depicting the future performance information are automatically performed in response to receiving the information related to the proposed motion picture.

90. The method of claim 88, wherein said receiving the information related to the proposed motion picture and transmitting one or more video segments depicting the future performance information occurs in approximately real-time.

91. The method of claim 88, wherein transmitting one or more video segments depicting the future performance information comprises transmitting a sequence of video segments of scenes of one or more motion pictures previously stored as archival performance information, wherein the sequence of video segments depict a possible sequence of scenes for the proposed motion picture.

92. The method of claim 91, wherein the sequence of scenes for the proposed motion represent scenes likely to produce a greatest popular appeal based at least in part upon the received information related to the proposed motion picture.

93. The method of claim 92, wherein receiving information related to the proposed motion picture comprises information related to a plot.

94. The method of claim 92, wherein receiving information related to the proposed motion picture comprises information related to an actor.

95. The method of claim 92, wherein receiving information related to the proposed motion picture comprises information related to a director.

96. A method, comprising:
performing future probability analysis based at least in part on information related to an athletic event;
assembling archival video materials in response to a result of the future probability analysis; and
transmitting the archival video materials.

97. The method of claim 96, wherein the athletic event comprises a pitched baseball, and further wherein the transmitted archival video materials comprise one or more video segments depicting a probable future sequence of pitches.

98. A method, comprising:
performing future probability analysis based at least in part on information related to a motion picture venture;
assembling archival video materials in response to a result of the future probability analysis; and
transmitting the archival video materials.

99. The method of claim 98, wherein the transmitted archival video materials comprise one or more video segments depicting scenes from one or more previous motion pictures.

100. The method of claim 99, wherein the information related to the motion picture comprises information related to a plot.

101. The method of claim 99, wherein the information related to the motion picture comprises information related to an actor.

102. The method of claim 99, wherein the information related to the motion picture comprises information related to a director.

103. An article, comprising: a storage medium having stored thereon instructions that, if executed, result in:
receiving present performance information;
synthesizing the received present performance information into a database comprising archival performance information;
calculating future performance information based at least in part on the present and archival performance information; and
transmitting the future performance information at least in part by transmitting one or more video segments depicting the future performance information.

104. The article of claim 103, wherein transmitting one or more video segments depicting the future performance information comprises transmitting one or more video segments previously stored as archival performance information.

105. The article of claim 104, wherein said synthesizing the received present performance information, said calculating the future performance information, and said transmitting one or more video segments depicting the future performance information are automatically performed in response to said receiving the present performance information.

106. The article of claim 105, wherein said receiving the present performance information and transmitting one or more video segments depicting the future performance information occurs in approximately real-time.

107. The article of claim 104, wherein receiving present performance information comprises receiving information related to a pitched baseball.

108. The article of claim 107, wherein the information related to the pitched baseball comprises a video segment depicting the pitched baseball.

109. The article of claim 108, wherein the information related to the pitched baseball further comprises text information describing one or more characteristics of the pitched baseball.

110. The article of claim 108, wherein transmitting one or more video segments depicting the future performance information comprises transmitting a sequence of video segments previously stored as archival performance information, wherein the sequence of video segments depict a likely future sequence of pitches.

111. An article, comprising: a storage medium having stored thereon instructions that, if executed, result in:
receiving information related to a business venture;
synthesizing the received information into a database comprising archival performance information;
calculating future performance information based at least in part on the received information related to the business venture and the archival performance information; and
transmitting the future performance information at least in part by transmitting one or more video segments depicting the future performance information.

112. The article of claim 111, wherein receiving information related to business venture comprises receiving information related to a proposed motion picture.

113. The article of claim 112, wherein transmitting one or more video segments depicting the future performance information comprises transmitting one or more video segments previously stored as archival performance information.

114. The article of claim 113, wherein said synthesizing the received present performance information, said calculating the future performance information, and said transmitting one or more video segments depicting the future performance information are automatically performed in response to receiving the information related to the proposed motion picture.

115. The article of claim 113, wherein said receiving the information related to the proposed motion picture and transmitting one or more video segments depicting the future performance information occurs in approximately real-time.

116. The article of claim 113, wherein transmitting one or more video segments depicting the future performance information comprises transmitting a sequence of video segments of scenes of one or more motion pictures previously stored as archival performance information, wherein the sequence of video segments depict a possible sequence of scenes for the proposed motion picture.

117. The article of claim 116, wherein the sequence of scenes for the proposed motion represent scenes likely to produce a greatest popular appeal based at least in part upon the received information related to the proposed motion picture.

118. The article of claim 117, wherein receiving information related to the proposed motion picture comprises information related to a plot.

119. The article of claim 117, wherein receiving information related to the proposed motion picture comprises information related to an actor.

120. The article of claim 117, wherein receiving information related to the proposed motion picture comprises information related to a director.

121. An article, comprising: a storage medium having stored thereon instructions that, if executed, result in:
performing future probability analysis based at least in part on information related to an athletic event;
assembling archival video materials in response to a result of the future probability analysis; and
transmitting the archival video materials.

122. The article of claim 121, wherein the athletic event comprises a pitched baseball, and further wherein the transmitted archival video materials comprise one or more video segments depicting a probable future sequence of pitches.

123. An article, comprising: a storage medium having stored thereon instructions that, if executed, result in:
performing future probability analysis based at least in part on information related to a motion picture venture;
assembling archival video materials in response to a result of the future probability analysis; and
transmitting the archival video materials.

124. The article of claim 123, wherein the transmitted archival video materials comprise one or more video segments depicting scenes from one or more previous motion pictures.

125. The article of claim 124, wherein the information related to the motion picture comprises information related to a plot.

126. The article of claim 124, wherein the information related to the motion picture comprises information related to an actor.

127. The article of claim 124, wherein the information related to the motion picture comprises information related to a director.

128. An apparatus, comprising:
a computing platform adapted to perform the method of claim 78 during operation.

129. The apparatus of claim 128, wherein the computing platform comprises at least in part a neural network.

130. An apparatus, comprising:
a computing platform adapted to perform the method of claim 86 during operation.

131. The apparatus of claim 130, wherein the computing platform comprises at least in part a neural network.

132. An apparatus, comprising:
a computing platform adapted to perform the method of claim 96 during operation.

133. The apparatus of claim 132, wherein the computing platform comprises at least in part a neural network.

134. An apparatus, comprising:
a computing platform adapted to perform the method of claim 98 during operation.

135. The apparatus of claim 134, wherein the computing platform comprises at least in part a neural network.
